(19) United States
(12) Patent Application Publication
(10) Pub. No.: US 2009/0268721 A1
(43) Pub. Date: Oct. 29, 2009

(54) TELEPHONE SYSTEM, ITS SERVER UNIT, AND DATABASE SYNCHRONIZATION METHOD

(75) Inventors: Fumio Shibasaki, Sagamihara-shi (JP); Shuichi Sato, Sagamihara-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/429,910

(22) Filed: Apr. 24, 2009

(30) Foreign Application Priority Data
Apr. 24, 2008 (JP) 2008-114234

(51) Int. Cl. H04L 12/66

(52) U.S. Cl. 370/352

(57) ABSTRACT

According to one embodiment, a telephone system comprises networks connected mutually, terminals and servers. The terminals belong to any one of the networks. The servers control each of networks and accommodate terminals. The server comprises database, manager and controller. The terminals and the server of their assignment destinations are associated with one another in the database. The manager updates to synchronize among the databases and the servers at movement destinations as the terminals under its own control move to control by other servers. The controller specifies a server for controlling a terminal at incoming call destination of outgoing call, destined to another network, from the databases transmit a call message to the specified server when the outgoing call toward another network is generated from the terminal under its own control to another network. The databases are sequentially synchronized among the servers as calls are generated among the terminals.

### CROSS-REFERENCE TO RELATED APPLICATIONS

This application is based upon and claims the benefit of priority from Japanese Patent Application No. 2008-114234, filed Apr. 24, 2008, the entire contents of which are incorporated herein by reference.

### BACKGROUND

1. Field

One embodiment of the present invention relates to, for example, a telephone system for achieving voice communication via, for example, an Internet Protocol (IP) network, a server unit for use in the system, and a database synchronous method.

2. Description of the Related Art

In recent years, as regards a telephone system, so-called Voice over IP (VoIP) for making voice communication using the IP network has become widely used. In this VoIP, installing a VoIP function on a personal computer, a personal digital assistant (PDA), etc., to connect it to a local area network (LAN) enables using the VoIP function as a telephone set. Since this kind of system controls outgoing/incoming calls on the basis of IP addresses, makes it easy to move telephone terminals.

In the system of this kind, an exchange server controls calls among telephone terminals. If a speech link is formed between an outgoing call terminal and an incoming call terminal, peer-to-peer communication maintains the speech link after this formation. A plurality of exchange servers are disposed with an increase in system scale. It is general form for a network of a metropolitan area network (MAN) to dispose one exchange server for each LAN and to transmit and receive messages among exchange servers in a call-connection sequence.

Meanwhile, in such a kind of form, each exchange server is provided with a database (hereinafter referred to as a positional information database) showing that which of networks includes each terminal, namely which of exchange servers controls each terminal. When receiving a call from a terminal controlled by itself to other LANs, each server specifies a server to which an incoming call destination terminal belongs on the basis of the positional information database to transmit a message to the specified server. However, if the positional information database has not been updated after a user (terminal) has moved, each server results in calling to any LAN in which there is no partner, and incoming calls are not received.

To solve such a defect, for example, Jpn. Pat. Appln. KOKAI Publication No. 2005-143099 has disclosed a technique by which when a positional information database at one place is updated, databases at other places are immediately synchronized with the update for moving of a service area (so-called roaming service) of a private wireless network. However, to synchronize a plurality of databases at every data update, there is a need for each exchange server to provide for processing ability with high speed and to accelerate communication channels among the exchange servers. Since these needs poses to increase in load of a system and to lead a cost increase of the system, it is required to implement some sort of countermeasures.

As mentioned above, since the existing telephone system consumes a large amount of processing ability and system resources such as a network capacity, the system is apt to cause various abuses such as an increase in cost, and countermeasures for the abuses should be taken.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system view depicting an embodiment of a telephone system of the invention;

FIG. 2 is a view depicting examples of positional information databases to be stored in positional information storage units M1-M3;

FIG. 3 is a flowchart depicting a processing procedure from an idle state of an exchange server;

FIG. 4 is a flowchart depicting a processing procedure from an intermediate state of call control of the exchange server;

FIG. 5 is a sequence view depicting an update processing procedure of a positional information database accompanied by a movement of a VoIP terminal;

FIG. 6 is a sequence view depicting an example of a processing procedure in originating a call;

FIG. 7 is a view depicting a state transition of the positional information database accompanied by a call processing sequence; and

FIG. 8 is a sequence view depicting another example of the processing procedure in originating a call.

### DETAILED DESCRIPTION

Various embodiments according to the invention will be described hereinafter with reference to the accompanying drawings. In general, according to one embodiment of the invention, there is provided a telephone system comprising networks connected to one another, telephone terminals belong to any one of the networks, and server units control each of networks and accommodate telephone terminals belonging to a network under its own control. The server unit comprises a positional information database, a positional information management module, and a call control module. The telephone terminals and the server unit of their assignment destinations are associated with one another in the positional information database. The management module updates to synchronize among the positional information databases and the server units at movement destinations as the telephone terminals under its own control move to control by other server units under its own control. The call control module specifies a server unit for controlling a telephone terminal at an incoming call destination of an outgoing call, destined to another network, from the positional information databases transmit a call message to the specified server unit when the outgoing call toward another network is generated from the telephone terminal under its own control to another network. The positional information databases are sequentially synchronized among the server units as calls are generated among the telephone terminals.

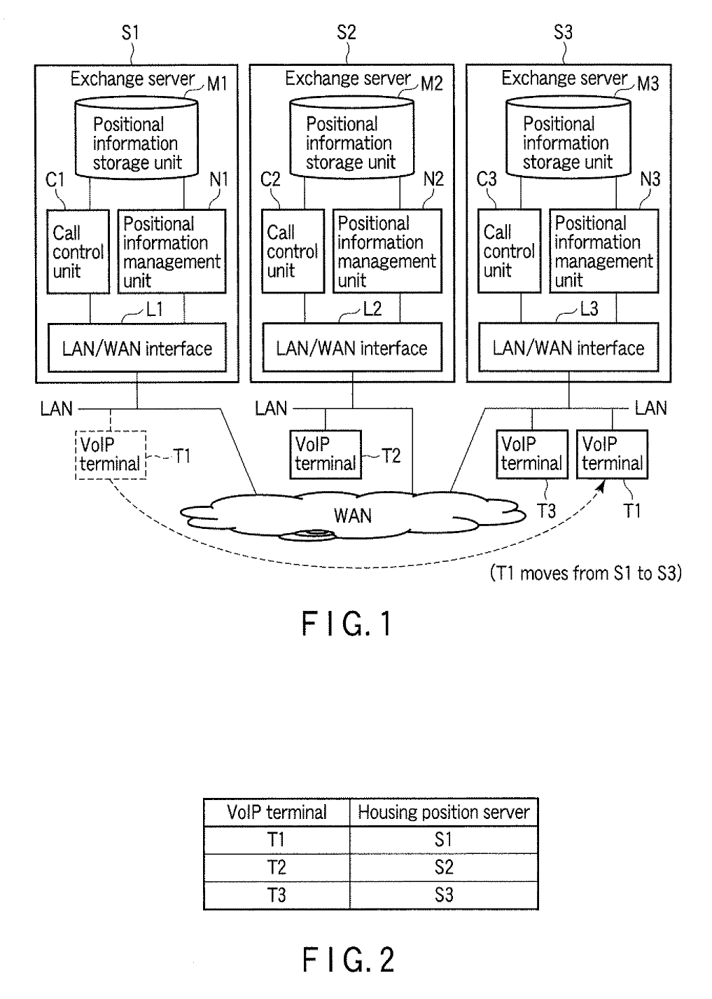

According to an embodiment, FIG. 1 shows a system view illustrating an embodiment of a telephone system of the invention. The system includes a plurality of LANs. Each LAN is connected with one another to form a wide area network (WAN). This system is a VoIP exchange network which forms a speech link by transmission and receiving, for example, a session initiation protocol (SIP) message.

Each LAN includes one of exchange servers S1, S2, S3, respectively. The exchange servers S1, S2, S3 control the respective LANs to accommodate VoIP terminals that are telephone terminals, respectively. In an initial state, it is assumed that a VoIP terminal T1 is controlled by exchange server S1, a VoIP terminal T2 is controlled by the exchange server 2, and a VoIP terminal T3 is controlled by the exchange server 3.

Exchange server S1 is connected to the VoIP exchange network via a LAN/WAN interface L1. Exchange server S1 further includes a positional information storage unit M1, a positional information management module N1, and a call control module C1. The other exchange servers S2 and S3 are configured similarly.

The positional information storage unit M1 stores, as shown, for example, in FIG. 2, a positional information database which has been converted into a database by associating each VoIP terminal in the system with an exchange server at its assignment destination. The positional information database in FIG. 2 shows correspondence relation in an initial state. When the VoIP terminal under its own control moving to control by another exchange server, the positional information management module N1 transmits and receives the SIP message, etc., to and from the exchange server at the movement destination, and updates mutual positional information databases. Thereby, the positional information databases immediately synchronize with each other between two exchange servers.

The call control module C1 controls call connection among the VoIP terminals. That is, the call control module C1 connects extension communication among the VoIP terminals in the LAN serving under the module C1 to control outside line connection via the WAN among the VoIP terminals by transmitting and receiving outgoing call messages to and from other exchange servers. Specifically, when an outgoing call from the VoIP terminal under its own control to the VoIP terminal under another LAN is generated, the call control module C1 specifies an exchange server which controls the VoIP terminal at the incoming call destination of the outgoing call from the positional information database in its own device to transmit the outgoing call message to the specified exchange server.

Especially, in the embodiment, if the received outgoing call message is destined to the VoIP terminal not controlled by its own call positional information management module N1, namely the received outgoing call message is destined to the VoIP terminal controlled by another exchange server, the module N1 implements peculiar processing. That is, when receiving such an outgoing call, the module N1 reports an assignment destination of the VoIP terminal of the incoming call destination to an exchange server at a transmission origin of the outgoing call message. For reporting the assignment destination, an SIP message may be used, and hereinafter this SIP message is referred to as a housing position report message.

The positional information management module (e.g., indicated by reference symbol N2) of the exchange server which has received the housing position report message updates the assignment destination of the VoIP terminal to be described in the housing position report message in the positional information database in its own server. Thereby, the positional information database of the exchange server which has received the housing position report message is also updated.

The call control module (e.g., indicated by reference symbol C2) of the exchange server which has been reported the housing position report message from another exchange server may correctly specify the exchange server to accommodate the VoIP terminal at the incoming call destination. Then, the call control module re-transmits the outgoing call message toward the specified exchange server.

Operations in the aforementioned configuration will be described hereinafter. In the following description, as shown in FIG. 1, it is assumed that VoIP terminal T1 which has been controlled by exchange server S1 in the initial state moves under the control of exchange server S3.

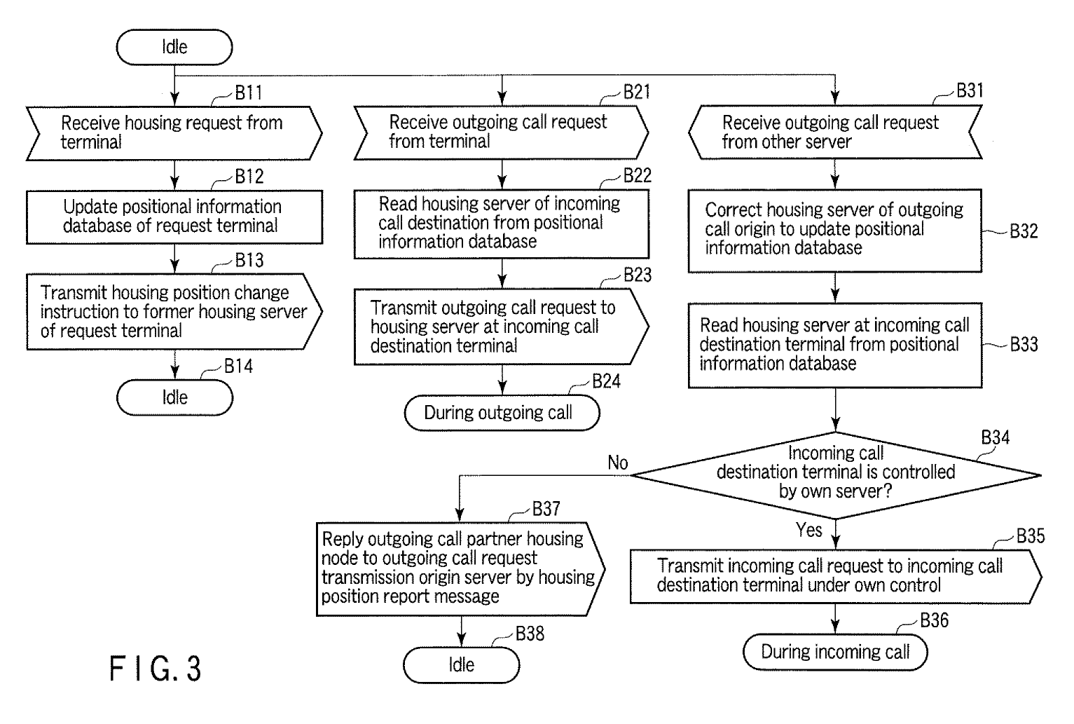

FIG. 3 is a flowchart illustrating a processing procedure from an idle state of the exchange server. In FIG. 3, when receiving a housing request from the VoIP terminal (Block B11), the exchange server updates the positional information database in its own server (Block 812), and also transmits a housing position change instruction message to a former housing server (i.e., an exchange server at a movement origin) of the requesting VoIP terminal (Block B13) to return to the idle state (Block B14). This procedure is equivalent to processing of exchange server S3 in FIG. 1.

When receiving an outgoing call request (outgoing call message) from the VoIP terminal (Block B21), the exchange server reads an exchange server for housing a terminal of an incoming call destination from the positional information database (Block B22), transmits the outgoing call request toward a read exchange server (Block B23) and then the exchange server enter an originating call state (Block B24).

When receiving an outgoing call request from another exchange server (Block B31), if the outgoing call origin VoIP terminal which has transmitted the outgoing call request is not controlled by its own exchange server, the exchange server corrects the housing server of the outgoing call origin VoIP terminal to update the positional information database of its own device (Block B32). The exchange server then reads an exchange server for housing an incoming call destination VoIP to be described in the received outgoing call request from the positional information database (Block B33), and determines whether or not the incoming call destination terminal is under the control by its own exchange server on the basis of the reading result (Block B34). If the incoming call destination terminal is under the control by its own exchange server, the exchange server transmits the incoming call request to the VoIP terminal (Block B35) to enter an incoming call state (Block B36).

If the incoming call destination VoIP terminal is not under the control of its own exchange server, the exchange server transmits a housing position report message including an identifier (address information, etc.) of the exchange server which has been read in Block B33 to an exchange server (outgoing call origin server) at an outgoing call origin of an outgoing call request then returns to the idle state (Block B38).

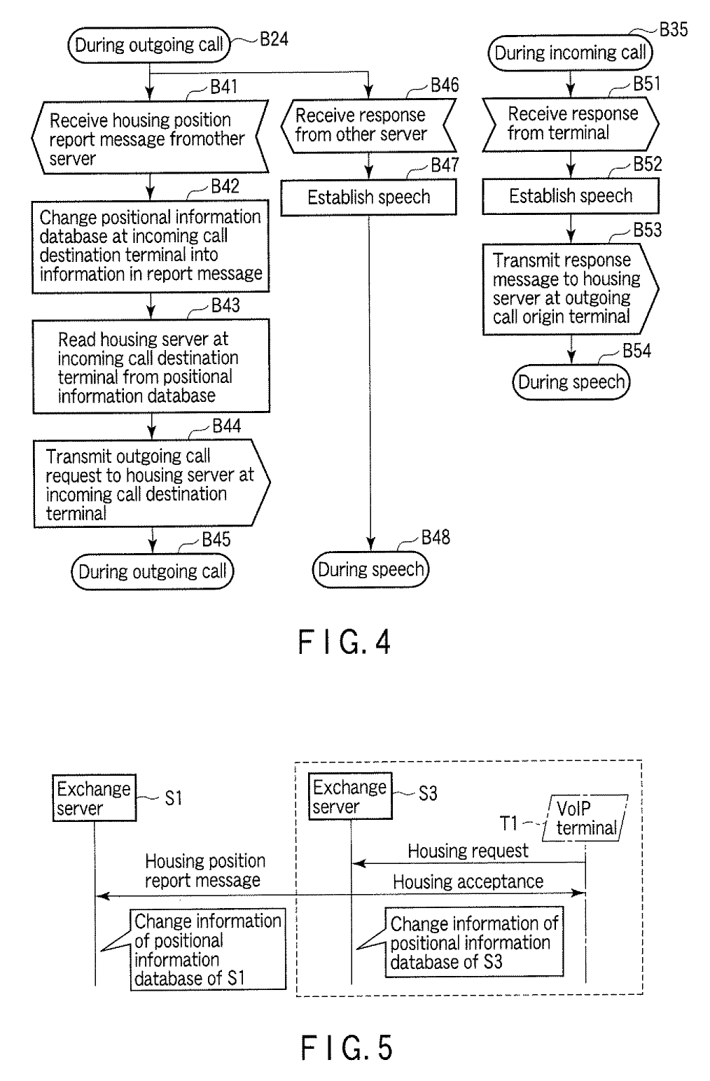

FIG. 4 shows a flowchart illustrating a processing procedure of call control from an immediate state (during outgoing call, during incoming call). Depending on the fact which message has been received from the outgoing call state in Block 24 of FIG. 3, procedures after this are switched. At first, when a response to the outgoing call request is received from another server (Block B46), a speech link among VoIP terminals is established in accordance with the existing sequence. Then, both the terminals at the outgoing call origin and the incoming call origin enter a speech state (Block B48).

Meanwhile, when receiving the housing position report message for the outgoing call request (Block B41), the exchange server which has received this report message reads the housing position information of the incoming call destination VoIP terminal from the report message to update its own positional information database (Block B42). The exchange server then reads which of the exchange servers accommodates the incoming call destination terminal from the updated positional information database (Block B43), and re-transmits the outgoing call request toward the read exchange server (Block B44). The state of the exchange server then enters again a state of outgoing call (Block B45).

After receiving the response message from the incoming call destination terminal under the control (Block B51) the exchange server during incoming call in Block B36 of FIG. 3 establishes a speech link through a defined sequence (Block B52). The exchange server replies a response message to the exchange server for housing the outgoing call origin terminal (Block B53) to enter the speech state (Block B54).

FIG. 5 shows a sequence view illustrating an update processing procedure of the positional information database accompanied by the movement of the VoIP terminal. This sequence corresponds to Blocks B11-B13 of FIG. 3. As shown in FIG. 1, it is assumed that VoIP terminal T1 moves from the control by exchange server S1 to the control by exchange server S3. VoIP terminal T1 then transmits a housing request message to an exchange server S3 that is a new assignment destination. Exchange server S3 which has received this request message replies a message with housing acceptance to VoIP terminal T1 and also transmits a housing position report message to exchange server S1. Thereby, the positional information databases are synchronized with the latest state between both exchange servers S1 and S3.

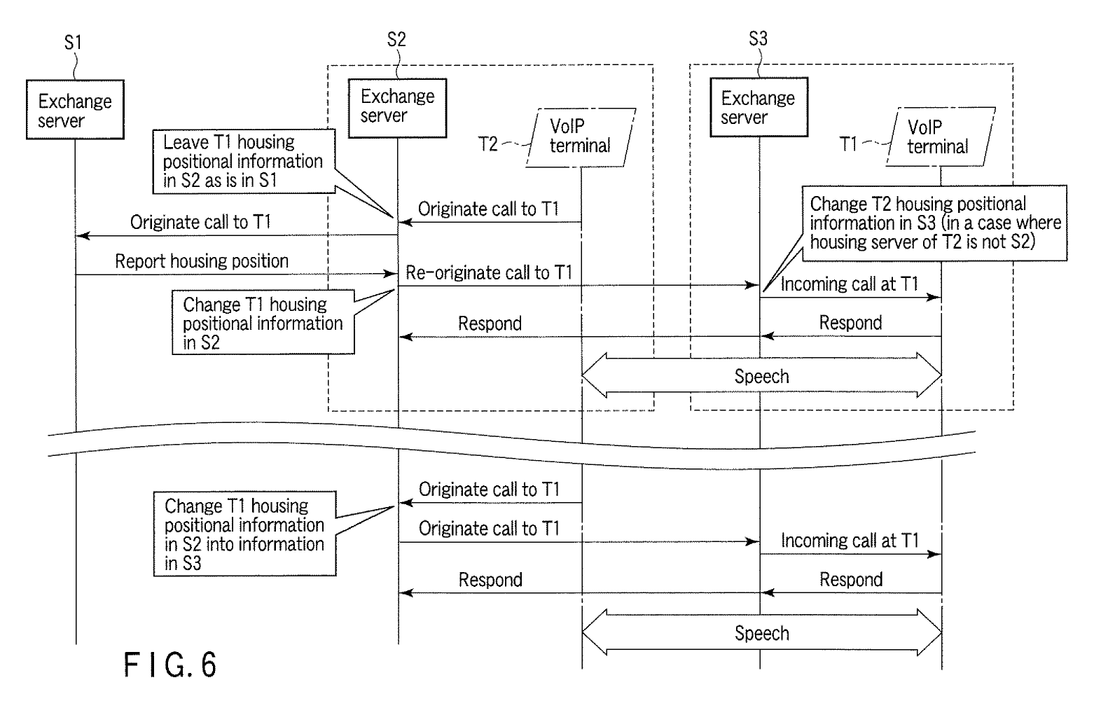

FIG. 6 shows a sequence view illustrating an example of a processing procedure in originating a call. FIG. 6 shows an outgoing call processing procedure from an exchange server where the positional information database is not the latest one, namely from an exchange server where the positional information database has not been synchronized with a new database. This procedure is equivalent to a state in which an outgoing call is made from the VoIP terminal under the control of exchange server S2.

It is assumed that, in FIG. 6, an outgoing call from VoIP terminal T2 to VoIP terminal T1 is generated. Then, at this moment, exchange server S2 recognizes that a housing position of VoIP terminal T1 is still under the control of exchange server S1. Exchange server S2 transmits an outgoing call message toward exchange server S1.

Meanwhile, since exchange server S1 knows that VoIP terminal T1 has moved under the control by exchange server S3, exchange server S1 reports this fact to exchange server S2 by means of the housing position report message. Exchange server S2 which has received this report message updates the positional information database stored in exchange server S2 itself, and at this moment, the positional information data abases of all the exchange servers are synchronized with the latest state. Exchange server S2 then re-transmits the outgoing call request toward exchange server S3.

When receiving the outgoing call request, exchange server S3 may recognize that the housing server for VoIP terminal T2 is exchange server S2. If the positional information database of exchange server S3 has not been updated so as to enable such recognition, exchange server S3 updates its own positional information database.

Since there is VoIP terminal T1 under the control by exchange server S3, exchange server S3 establishes a speech link in accordance with the procedures of Blocks B31-B36 in FIG. 3, after this, the speech between VoIP terminal T2 and VoIP terminal T1 is started. After the termination of the speech, when an outgoing call from VoIP terminal T2 to VoIP terminal T1 is generated again, after this, the exchange server V2 may correctly recognize the housing destination for VoIP terminal T1. Therefore, the existing call processing sequence without being accompanied by the process of the database synchronization is implemented.

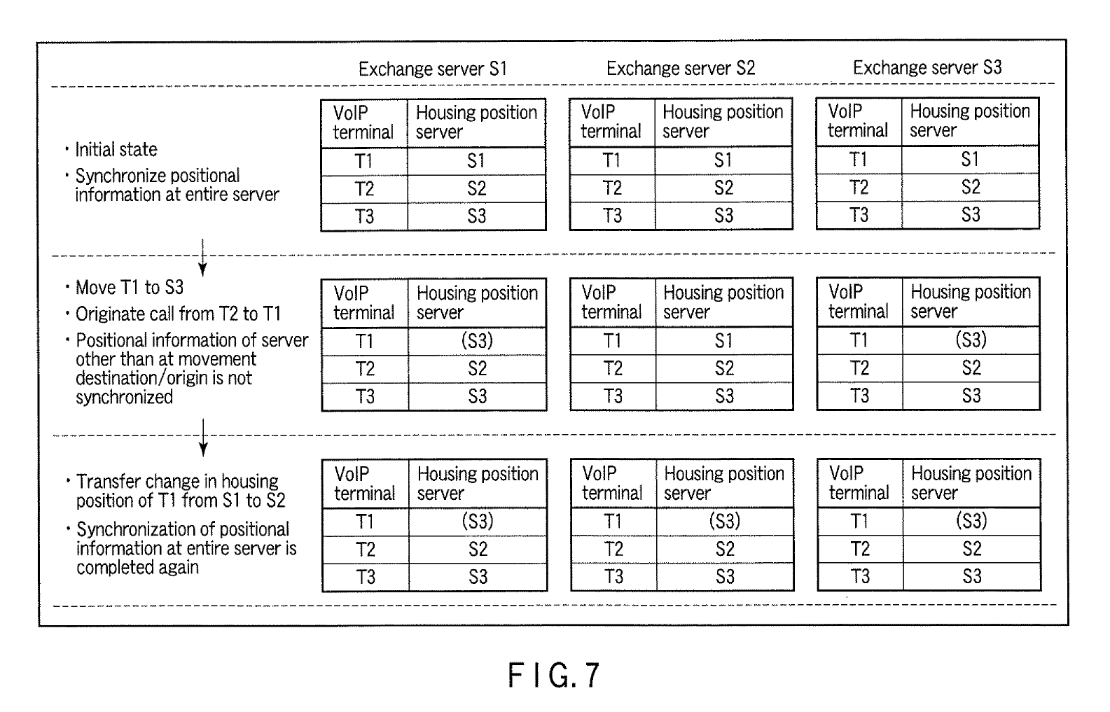

FIG. 7 shows a view illustrating a state transition of the positional information database with the call processing sequence. The parenthetic symbols in FIG. 7 indicate the update of the data in the positional information databases. In an initial state, the positional information databases of all the exchange severs S1-S3 are in a synchronized state. When VoIP terminal T1 moves from this initial state, only the positional information databases of the server (exchange server S1) at the movement origin and the server (exchange server S3) at the movement destination are synchronized with each other, and the former database of exchange server S2 still remains. However, if the outgoing call from the VoIP terminal under the control of exchange server S2 is generated from the state of the above, the positional information report message is reported to exchange server S2. Thereby, the positional information databases of all the exchange servers S1-S3 are in the synchronized state again.

As mentioned above, in this embodiment, when the VoIP terminal has moved, the positional information databases are firstly synchronized only between the exchange servers at the movement origin and the movement destination. After this, when an outgoing call from an exchange server having an unsynchronized positional information database is generated, the exchange server which has received this outgoing call reports a positional information report message based on the latest positional information database to the exchange server at the outgoing call origin. Thereby, the positional information databases are finally synchronized with one another at all the exchange servers, and re-originating the call from the exchange server which has received the positional information report message also enables surely forming the speech link.

Like this way, since there is no need to synchronize the databases among all the exchange servers at every time when the positions of the VoIP terminals vary, a load on system resources may be suppressed to the minimum. The synchronization processing sequence is implemented when a call to the moved terminal is generated at the first time from the unsynchronized server. Therefore, in comparison to implement the synchronization processing, like the existing technique, simultaneously among servers, the processing ability of the exchange server and a bit rate inter-server communication path may be suppressed, and an effect to reduce a cost becomes high. Even in a state in which the databases are not synchronized one another, since the positional information of the moved VoIP terminal may be traced, the telephone system may surely continue outgoing and incoming call services.

Further, according to the embodiment, since a line capacity for synchronizing the databases may be suppressed lower, the telephone system easily corresponds to connect LANs one after another and expands a system scale. This becomes advantageous for connecting distributed systems in a module manner and for forming a large-scaled system.

Moreover, transmitting and receiving the outgoing call among exchange servers enables obtaining a trigger of updating the positional information database not only on a caller side but also on an incoming call side when incoming call is received. This processing is shown in the processing, for example, in the processing in Block B32 of FIG. 3. That is, since the outgoing call origin of the message to be transmitted and received among the exchange servers is described, the exchange server which has received the message may detect a discrepancy between the message and the positional information database in its own server at every time. Like this way, updating the databases at both the caller and the recipient enables shortening the time up to the synchronization.

Therefore, the load related to the synchronization of the positional information databases among servers may be minimized; thereby it becomes able to provide the telephone system for reducing the system load and costs, its server unit, and the database synchronization method.

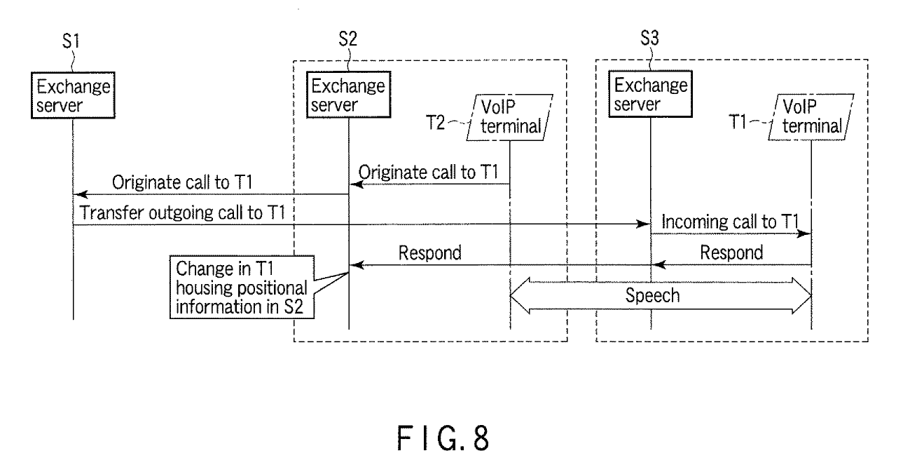

The invention is not limited to the foregoing embodiments. FIG. 8 shows a sequence view illustrating another example of the processing procedure in originating the call. When receiving the outgoing call to VoIP terminal T1 in this sequence, exchange server S1 transfers the outgoing call message to exchange server S3. In response to this transfer, the call connection sequence runs between exchange servers S2 and S3 to form the speech link. At this moment, exchange server SB transmits a response message to exchange server S2, and exchange server S2 recognizes that VoIP terminal T1 moves under the control by exchange server S3. At this time point, exchange server S2 updates its own positional information database. Also in this way, the position of the VoIP terminal may be correctly traced.

In comparison between the sequence views of FIG. 8 and FIG. 6, since the outgoing processing implemented by exchange server S2 may be ended only one time, the procedure may be simplified, and the telephone system has an effect on reduction in data amount related to transmit and receive messages.

Further, the number of the LANs in FIG. 1 is not limited to three, and in response to this non-limitation, the number of the exchange servers is set arbitrarily. According to the procedure of the invention, whatever the number of the exchange servers is large, all databases are finally synchronized with one another as the calling is generated.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system comprising:
networks which are connected to one another;
telephone terminals which belong to any one of the networks; and
server units which control each of networks and accommodate telephone terminals belonging to a network under its own control, wherein
the server unit comprises:
a positional information database in which the telephone terminals and the server unit of their assignment destinations are associated with one another;
a positional information management module which updates to synchronize among the positional information databases and the server units at movement destinations as the telephone terminals under its own control move to control by other server units under its own control; and
a call control module which specifies a server unit for controlling a telephone terminal at an incoming call destination of an outgoing call, destined to another network, from the positional information databases transmit a call message to the specified server unit when the outgoing call toward another network is generated from the telephone terminal under its own control to another network, and
the positional information databases are sequentially synchronized among the server units as calls are generated among the telephone terminals.

2. The telephone system of claim 1, wherein:
when a call message destined to a telephone terminal under another server unit, the positional information management module reports an assignment destination of a telephone terminal at the incoming call destination by means of a positional message to a server unit at a transmission origin of the call message,
when the positional messages is reported from another server unit, the positional information management module updates the assignment destination of the telephone terminal in the positional information database in its own unit, and
when the positional message is reported from the server unit, the call control module re-transmits the call message to the updated server unit at the assignment destination.

3. The telephone system of claim 1, wherein
when receiving the call message from another server unit, the call control module transfers the call message to the updated server units at the assignment destination; and
when receiving a response to the transferred call message, the positional information management module updates the assignment destination of the telephone terminal of the incoming call destination of the call message in the positional information database in its own unit.

4. A server unit which is provided for a telephone system including networks which are connected with one another and telephone terminals assigned to any one of the networks, and controls one network and accommodates telephone terminals belonging to a network under its own control, the server unit comprising:
a positional information database in which the plurality of telephone terminals and server units of their assignment destinations are associated with one another;
a positional information management module which updates to synchronize among the positional information databases and the server units at movement destinations as the telephone terminals under its own control move to control by other server units under its own control; and
a call control module which specifies a server unit for controlling a telephone terminal at an incoming call destination of an outgoing call, destined to another network, from the positional information database transmit a call message to the specified server unit when the outgoing call toward another network is generated from the telephone terminal under its own control to another network, and the positional information databases are sequentially synchronized among other server units as calls are generated among the telephone terminals.

5. The server unit of claim 4, wherein:
when a call message destined to a telephone terminal under another server unit, the positional information management module reports an assignment destination of a telephone terminal at the incoming call destination by means of a positional message to a server unit at a transmission origin of the call message,
when the positional messages is reported from another server unit, the positional information management module updates the assignment destination of the telephone terminal in the positional information database in its own unit, and
when the positional message is reported from the server unit, the call control module re-transmits the call message to the updated server unit at the assignment destination.

6. The server unit of claim 4, wherein
when receiving the call message from another server unit, the call control module transfers the call message to the updated server units at the assignment destination; and
when receiving a response to the transferred call message, the positional information management module updates the assignment destination of the telephone terminal of the incoming call destination of the call message in the positional information database in its own unit.

7. A database synchronization method for mutually synchronizing positional information databases of server units, which is provided for a telephone system including networks connected with one another and telephone terminals assigned to any one of the networks, in which a plurality of terminal devices and server units at the assignment destinations of the terminal devices are associated with one another, the method comprising:
updating, by the server unit, to synchronize among the positional information databases and the server units at movement destinations as the telephone terminals under its own control move to control by another server unit;
specifying, by the server unit, a server unit which controls a telephone terminal at an incoming call destination from the positional information databases when a call toward another network is generated from the telephone terminal under its own control;
transmitting, by the server unit, a call message to the specified server unit; and
sequentially synchronizing, by the server unit, the positional information databases with other server units as calls are generated among the plurality of telephone terminals.

8. The database synchronization method of claim 7, further comprising:
reporting, by the server unit which receives a call message destined to telephone terminals under another server unit, assignment destination of telephone terminal at the call destination by means of a positional message to a server unit at an outgoing call origin of the call message;
updating, by the server unit which is reported the position message from another server unit, the assignment destinations of the telephone terminals in the positional information databases in its own unit; and
re-transmitting, by the server unit which is reported the position message from another server unit, the call message to server unit at the updated assignment destination.

9. The database synchronization method of claim 7, further comprising:
transferring, by the server unit which receives the call message from another server unit, the call message to the server unit at the updated assignment destination; and
updating, by the server unit which receives responses to the transferred call message, the assignment destination of the telephone terminal at the incoming call destination of call messages in the positional information database in its own unit.
